(19) United States
(12) Patent Application Publication
(10) Pub. No.: US 2026/0204546 A1
(43) Pub. Date: Jul. 16, 2026

(54) ELECTRODE ACTIVE MATERIAL COMPOSITE PARTICLE, METHOD FOR PRODUCING THE SAME, ELECTRODE COMPOSITE, AND BATTERY

(71) Applicant: TOYOTA JIDOSHA KABUSHIKI KAISHA, Toyota-shi (JP)

(72) Inventors: Kazushige NOMOTO, Shizuoka-ken (JP); So Kudo, Shizuoka-ken (JP)

(73) Assignee: TOYOTA JIDOSHA KABUSHIKI KAISHA, Toyota-shi (JP)

(21) Appl. No.: 19/406,132

(22) Filed: Dec. 2, 2025

(30) Foreign Application Priority Data
Jan. 14, 2025 (JP) 2025-005013

(51) Int. Cl. H01M 4/36; H01M 4/02; H01M 4/04; H01M 4/38; H01M 4/62

(52) U.S. Cl. CPC H01M 4/364; H01M 4/0419; H01M 4/386; H01M 4/623; H01M 2004/027

(57) ABSTRACT

An electrode active material composite particle is a composite particle containing a plurality of silicon particles and a binder. In the electrode active material composite particle, the binder contains a fluorine-based polymer and a non-fluorine-based polymer. In the electrode active material composite particle, a content ratio of the fluorine-based polymer in an inner region of the composite particle is greater than a content ratio of the fluorine-based polymer in an outer region of the composite particle, and a content ratio of the non-fluorine-based polymer in the outer region of the composite particle is greater than a content ratio of the non-fluorine-based polymer in the inner region of the composite particle. An electrode composite contains the electrode active material composite particle. A battery includes an electrode active material layer, and the electrode active material layer contains the electrode composite.

### CROSS-REFERENCE TO RELATED APPLICATION

This application claims priority to Japanese Patent Application No. 2025-005013 filed on Jan. 14, 2025. The disclosure of the above-identified application, including the specification, drawings, and claims, is incorporated by reference herein in its entirety.

### BACKGROUND

### 1. Technical Field

The present disclosure relates to an electrode active material composite particle, a method for producing the same, an electrode composite, and a battery.

### 2. Description of Related Art

As disclosed in Japanese Unexamined Patent Application Publication Nos. 2024-111770 (JP 2024-111770 A) and 2024-086275 (JP 2024-086275 A), there are known electrode active material composite particles each containing a plurality of silicon particles as electrode active material particles and a fluorine-based polymer as a binder.

### SUMMARY

In a battery containing electrode active material composite particles each containing a plurality of silicon particles and a fluorine-based polymer, there is room for improvement in terms of reducing irreversible capacity.

An object of the present disclosure is to provide an electrode active material composite particle in which irreversible capacity of a battery can be reduced, a method for producing the same, an electrode composite containing such an electrode active material composite particle, and a battery containing such an electrode composite.

The present inventors have found that the above issue can be addressed by the following measures.

### First Aspect

An electrode active material composite particle that is a composite particle containing a plurality of silicon particles and a binder, in which
the binder contains a fluorine-based polymer and a non-fluorine-based polymer,
a content ratio of the fluorine-based polymer in an inner region of the composite particle is greater than a content ratio of the fluorine-based polymer in an outer region of the composite particle, and
a content ratio of the non-fluorine-based polymer in the outer region of the composite particle is greater than a content ratio of the non-fluorine-based polymer in the inner region of the composite particle.

### Second Aspect

The electrode active material composite particle according to the first aspect, in which:
a content ratio of the fluorine-based polymer with respect to 100 parts by mass of the silicon particles is 30 parts by mass or less; and
a content ratio of the non-fluorine-based polymer with respect to 100 parts by mass of the silicon particles is 15 parts by mass or less.

### Third Aspect

An electrode composite containing the electrode active material composite particle according to the first or second aspect.

### Fourth Aspect

A battery including an electrode active material layer, in which the electrode active material layer contains the electrode composite according to the third aspect.

### Fifth Aspect

A method for producing the electrode active material composite particle according to the first or second aspect, the method including:
providing a first slurry containing the silicon particles, the fluorine-based polymer, and a first dispersion medium;
drying and removing the first dispersion medium by spray drying to prepare a preliminary composite particle;
providing a second slurry containing the preliminary composite particle, the non-fluorine-based polymer, and a second dispersion medium; and
drying and removing the second dispersion medium by spray drying.

According to the present disclosure, it is possible to provide the electrode active material composite particle in which the irreversible capacity of the battery can be reduced, the method for producing the same, the electrode composite containing such an electrode active material composite particle, and the battery containing such an electrode composite.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of an electrode active material composite particle of the present disclosure.

### DETAILED DESCRIPTION OF EMBODIMENTS

An embodiment of the present disclosure will be described below in detail. The present disclosure is not limited to the following embodiment, and various modifications may be made within the scope of the present disclosure.

### Electrode Active Material Composite Particle

The electrode active material composite particle of the present disclosure is a composite particle containing a plurality of silicon particles and a binder. In the electrode active material composite particle of the present disclosure, the binder contains a fluorine-based polymer and a non-fluorine-based polymer. In the electrode active material composite particle of the present disclosure, the content ratio of the fluorine-based polymer in an inner region of the composite particle is greater than the content ratio of the fluorine-based polymer in an outer region of the composite particle, and the content ratio of the non-fluorine-based polymer in the outer region of the composite particle is greater than the content ratio of the non-fluorine-based polymer in the inner region of the composite particle.

Without intending to be bound by any theory, the present inventors believe that one of the causes of an increase in irreversible capacity of a battery containing electrode active material composite particles each containing a plurality of silicon particles and a fluorine-based polymer as a binder is reaction of the fluorine-based polymer with lithium ions.

The present inventors have found that the irreversible capacity of a battery can be reduced when a binder contains a fluorine-based polymer and a non-fluorine-based polymer, a larger amount of the fluorine-based polymer is present in the inner region of the composite particle, and a larger amount of the non-fluorine-based polymer is present in the outer region of the composite particle.

The reason for this is presumed to be as follows, without intending to be bound by any theory. That is, it is believed that the non-fluorine-based polymer present in a larger amount in the outer region can suppress contact between an electrolyte and the fluorine-based polymer present in a larger amount in the inner region. It is thus believed that the reaction between the fluorine-based polymer and lithium ions can be suppressed, thereby reducing the irreversible capacity of the battery.

In the present disclosure, the “electrode active material” may be either a “cathode active material” or an “anode active material,” and may particularly be the “anode active material.”

In the present disclosure, the “fluorine-based polymer” refers to a polymer that contains fluorine, and the “non-fluorine-based polymer” refers to a polymer that does not contain fluorine.

In the present disclosure, the “outer region” and the “inner region” of the composite particle can be defined as follows. That is, when the cross section of the electrode active material composite particle is observed and a boundary is observed between a layer containing a larger amount of the non-fluorine-based polymer and a layer inward thereof, the layer outward of the boundary can be regarded as the outer region, and the layer inward of the boundary can be regarded as the inner region. When the cross section of the electrode active material composite particle is observed and no boundary is observed between the outer region and the inner region inward thereof, the outer region and the inner region can be distinguished as follows. That is, the cross section of the electrode active material composite particle is analyzed by scanning electron microscope energy dispersive X-ray spectroscopy (SEM-EDX) etc. to obtain a sectional image of the electrode active material composite particle. When the sectional area of a region from the surface of the electrode active material composite particle to a predetermined depth in the sectional image is a1 and the sectional area of the entire particle is a1+a2, a region where a1/(a1+a2) is 0.5 can be regarded as the outer region. The portion deeper (inner portion) than the identified outer region can be regarded as the inner region.

Each element constituting the electrode active material composite particle of the present disclosure will be described below.

### Silicon Particles

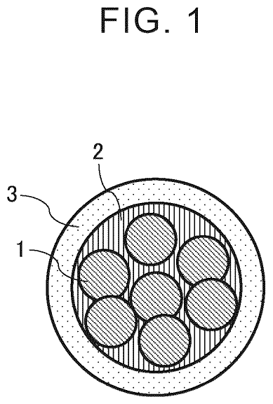

As illustrated in FIG. 1, the electrode active material composite particle of the present disclosure includes a plurality of silicon particles 1. The silicon particles can act as an electrode active material. The number of silicon particles contained in the electrode active material composite particle is not particularly limited.

In the present disclosure, the “silicon particle” is not particularly limited as long as it contains silicon and can act as the electrode active material. Examples of the silicon particle include a pure silicon particle, a silicon alloy particle (e.g., alloys of Si with one or more metals selected from the group consisting of Sn, Ti, Fe, Ni, Cu, Co, and Al), a porous silicon particle, a silicon clathrate particle, a silicon oxide particle, and a mixture thereof. The silicon particle may be one type alone, or two or more types in combination.

The silicon particle may be either amorphous or crystalline. The crystalline phase contained in the silicon particle is not particularly limited.

The content of the silicon particles in the electrode active material composite particle is not particularly limited, and can be set as appropriate in consideration of a desired battery capacity etc.

### Binder

The electrode active material composite particle of the present disclosure contains a binder. As illustrated in FIG. 1, the binder contains a fluorine-based polymer 2 and a non-fluorine-based polymer 3.

The fluorine-based polymer is not particularly limited as long as it is a polymer containing fluorine, and may be, for example, polyvinylidene difluoride (PVDF), polyvinylidene difluoride-polyhexafluoropropylene copolymer (PVDF-HFP), polytetrafluoroethylene, fluororubber, or a combination thereof. The silicon particle may expand and contract as the battery is charged and discharged. The fluorine-based polymer has a moderate elastic modulus and therefore can easily follow such expansion and contraction. Thus, the electrode active material composite particle containing the fluorine-based polymer can easily maintain its structure.

The non-fluorine-based polymer is not particularly limited as long as it is a polymer that does not contain fluorine, and may be, for example, styrene butadiene rubber (SBR), nitrile butadiene rubber (NBR), polyimide, an acrylic acid-based polymer, polyvinyl butyral, or a combination thereof.

In the electrode active material composite particle of the present disclosure, the content ratio of the fluorine-based polymer in the inner region of the composite particle is greater than the content ratio of the fluorine-based polymer in the outer region of the composite particle, and the content ratio of the non-fluorine-based polymer in the outer region of the composite particle is greater than the content ratio of the non-fluorine-based polymer in the inner region of the composite particle. In other words, a larger amount of the fluorine-based polymer is present in the inner region of the composite particle, and a larger amount of the non-fluorine-based polymer is present in the outer region of the composite particle. Thus, it is possible to suppress contact between the fluorine-based polymer and the electrolyte, that is, to suppress reaction between the fluorine-based polymer and lithium ions, thereby reducing the irreversible capacity of the battery.

The fact that the content ratio of the fluorine-based polymer in the inner region of the composite particle is greater than the content ratio of the fluorine-based polymer in the outer region of the composite particle and the content ratio of the non-fluorine-based polymer in the outer region of the composite particle is greater than the content ratio of the non-fluorine-based polymer in the inner region of the composite particle can be checked, for example, by analyzing the cross section of the composite particle itself or an electrode active material layer made of an electrode composite containing the composite particle using scanning electron microscope energy dispersive X-ray spectroscopy (SEM-EDX).

In the present disclosure, the “composite” refers to a composition that can constitute an active material layer either as it is or by further containing other components. In the present disclosure, a “composite slurry” refers to a slurry that contains a dispersion medium in addition to the “composite” and that can be applied and dried to form an active material layer.

The inner region of the composite particle may contain both the fluorine-based polymer 2 and the non-fluorine-based polymer 3 as the binder, but may particularly contain only the fluorine-based polymer 2 as illustrated in FIG. 1. Thus, the irreversible capacity of the battery can be reduced effectively.

The outer region of the composite particle may contain both the non-fluorine-based polymer 3 and the fluorine-based polymer 2 as the binder, but may particularly contain only the non-fluorine-based polymer 3 as illustrated in FIG. 1. Thus, the irreversible capacity of the battery can be reduced effectively.

The ratio of the fluorine-based polymer with respect to 100 parts by mass of the silicon particles in the electrode active material composite particle may be 30 parts by mass or less, and the content ratio of the non-fluorine-based polymer may be 15 parts by mass or less. Thus, the irreversible capacity of the battery can be reduced effectively.

The content ratio of the fluorine-based polymer with respect to 100 parts by mass of the silicon particles may be 0.1 parts by mass or more, 0.5 parts by mass or more, 1 part by mass or more, 5 parts by mass or more, 10 parts by mass or more, or 15 parts by mass or more, and may be 30 parts by mass or less, 20 parts by mass or less, 15 parts by mass or less, or 10 parts by mass or less. The content ratio may be 10 parts by mass or more and 15 parts by mass or less.

The content ratio of the non-fluorine-based polymer with respect to 100 parts by mass of the silicon particles may be 0.01 parts by mass or more, 0.05 parts by mass or more, 0.1 parts by mass or more, 0.5 parts by mass or more, 0.8 parts by mass or more, 1 part by mass or more, 3 parts by mass or more, or 5 parts by mass or more, and may be 15 parts by mass or less, 10 parts by mass or less, 8 parts by mass or less, 5 parts by mass or less, 3 parts by mass or less, or 1 part by mass or less. The content ratio may be 0.5 parts by mass or more and 10 parts by mass or less, 0.8 parts by mass or more and 8 parts by mass or less, or 1 part by mass or more and 5 parts by mass or less.

The total content ratio of the fluorine-based polymer and the non-fluorine-based polymer with respect to 100 parts by mass of the silicon particles in the electrode active material composite particle is not particularly limited, but may be, for example, 1 part by mass or more, 3 parts by mass or more, 5 parts by mass or more, 10 parts by mass or more, 10.5 parts by mass or more, 11 parts by mass or more, 13 parts by mass or more, or 15 parts by mass or more, and may be 30 parts by mass or less, 25 parts by mass or less, 20 parts by mass or less, 18 parts by mass or less, 15 parts by mass or less, 13 parts by mass or less, or 11 parts by mass or less.

The ratio of the mass of the non-fluorine-based polymer to the mass of the fluorine-based polymer in the electrode active material composite particle is not particularly limited, but may be, for example, 0.01 or more, 0.03 or more, 0.05 or more, 0.1 or more, 0.3 or more, or 0.5 or more, and may be 10 or less, 5 or less, 3 or less, 2 or less, 1 or less, 0.5 or less, 0.3 or less, or 0.1 or less. Thus, the irreversible capacity of the battery can be reduced effectively.

### Method for Producing Electrode Active Material Composite Particle

The method of the present disclosure for producing the electrode active material composite particle includes the following steps: providing a first slurry containing silicon particles, a fluorine-based polymer, and a first dispersion medium; drying and removing the first dispersion medium by spray drying to prepare a preliminary composite particle; providing a second slurry containing the preliminary composite particle, a non-fluorine-based polymer, and a second dispersion medium; and drying and removing the second dispersion medium by spray drying.

In the electrode active material composite particle produced by such a method, the content ratio of the fluorine-based polymer in the inner region of the composite particle is greater than the content ratio of the fluorine-based polymer in the outer region of the composite particle, and the content ratio of the non-fluorine-based polymer in the outer region of the composite particle is greater than the content ratio of the non-fluorine-based polymer in the inner region of the composite particle.

### First Slurry Providing Step

The method of the present disclosure includes providing the first slurry containing the silicon particles, the fluorine-based polymer, and the first dispersion medium.

For the silicon particles and the fluorine-based polymer, the above description can be referenced.

The first dispersion medium is not particularly limited as long as the silicon particles can be dispersed and the fluorine-based polymer can be dissolved or dispersed.

### Preliminary Composite Particle Preparation Step (First Dispersion Medium Drying and Removing Step)

The method of the present disclosure includes drying and removing the first dispersion medium by spray drying to prepare the preliminary composite particle. By first preparing the preliminary composite particle containing the silicon particles and the fluorine-based polymer, the content ratio of the fluorine-based polymer in the inner region of the composite particle can be made greater than the content ratio of the fluorine-based polymer in the outer region of the composite particle.

The drying conditions of the spray drying, such as a drying temperature and a drying time, are not particularly limited and can be set as appropriate in consideration of the solid content ratio of the first slurry, the boiling point of the first dispersion medium, etc.

### Second Slurry Providing Step

The method of the present disclosure includes providing the second slurry containing the preliminary composite particle, the non-fluorine-based polymer, and the second dispersion medium.

For the non-fluorine-based polymer, the above description can be referenced.

The second dispersion medium is not particularly limited as long as the preliminary composite particle can be dispersed and the non-fluorine-based polymer can be dissolved or dispersed. The second dispersion medium may be the same as or different from the first dispersion medium.

### Second Dispersion Medium Drying and Removing Step

The method of the present disclosure includes drying and removing the second dispersion medium by spray drying. By compounding the preliminary composite particle with the non-fluorine-based polymer, the content ratio of the non-fluorine-based polymer in the outer region of the composite particle can be made greater than the content ratio of the non-fluorine-based polymer in the inner region of the composite particle.

The drying conditions of the spray drying, such as a drying temperature and a drying time, are not particularly limited and can be set as appropriate in consideration of the solid content ratio of the second slurry, the boiling point of the second dispersion medium, etc.

### Electrode Composite

The electrode composite of the present disclosure contains the electrode active material composite particle of the present disclosure. The electrode composite may optionally contain a solid electrolyte, a conductive aid, a binder, etc.

### Electrode Active Material Composite Particle

For the electrode active material composite particle of the present disclosure, the above description can be referenced.

The content of the electrode active material composite particles in the electrode composite is not particularly limited, and can be set as appropriate in consideration of a desired battery capacity etc.

### Solid Electrolyte

The solid electrolyte is not particularly limited, and may be, for example, an inorganic solid electrolyte such as a sulfide solid electrolyte, an oxide solid electrolyte, a nitride solid electrolyte, or a halide solid electrolyte, or an organic polymer electrolyte such as a polymer electrolyte. The solid electrolyte may particularly be the sulfide solid electrolyte.

When the electrode composite of the present disclosure is an electrode composite for a lithium ion secondary battery, examples of the sulfide solid electrolyte having lithium ion conductivity include a solid electrolyte containing a Li element, an X element (X is at least one of P, As, Sb, Si, Ge, Sn, B, Al, Ga, and In), and a S element. The sulfide solid electrolyte may further contain at least one of an O element and a halogen element. The halogen element may be, for example, a F element, a Cl element, a Br element, or an I element.

The sulfide solid electrolyte may be, for example, Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numerals, and Z is any one of Ge, Zn, and Ga), Li₂S—GeS₂, Li₂S—SiS₂—Li₃PO₄, Li₂S—SiS₂—LiₓMO_{y} (where x and y are positive numerals, and M is any one of P, Si, Ge, B, Al, Ga, and In), or a combination thereof.

The content of the solid electrolyte in the electrode composite is not particularly limited, and can be set as appropriate in consideration of a desired ion conductivity etc.

### Conductive Aid

The conductive aid may be, for example, a carbon material, metal particles, or a combination thereof. The carbon material may be, for example, a non-fibrous carbon material such as acetylene black (AB) or Ketjen black (KB); a fibrous carbon material such as vapor grown carbon fiber (VGCF), carbon nanotube (CNT), or carbon nanofiber (CNF); or a combination thereof. The metal particles may be, for example, nickel, copper, iron, stainless steel, or a combination thereof.

The content of the conductive aid in the electrode composite is not particularly limited, and can be set as appropriate in consideration of a desired electronic conductivity etc.

### Binder

The binder may be the same as or different from the binder used to prepare the electrode active material composite particle. The binder may be, for example, a rubber-based binder such as butadiene rubber, hydrogenated butadiene rubber, styrene butadiene rubber (SBR), hydrogenated styrene butadiene rubber, nitrile butadiene rubber, hydrogenated nitrile butadiene rubber, acrylate butadiene rubber (ABR), or ethylene propylene rubber; a fluoride-based binder such as polyvinylidene difluoride (PVDF), polyvinylidene difluoride-polyhexafluoropropylene copolymer (PVDF-HFP), polytetrafluoroethylene, or fluororubber; a polyolefin-based thermoplastic resin such as polyethylene, polypropylene, or polystyrene; an imide-based resin such as polyimide or polyamideimide; an amide-based resin such as polyamide; an acrylic resin such as polymethyl acrylate or polyethyl acrylate; a methacrylic resin such as polymethyl methacrylate or polyethyl methacrylate; or a combination thereof.

The content of the binder in the electrode composite is not particularly limited, and can be set as appropriate in consideration of desired binding properties etc.

### Battery

The battery of the present disclosure includes an electrode active material layer, and the electrode active material layer contains the electrode composite. The battery of the present disclosure may include an anode current collector layer, an anode active material layer, an electrolyte layer, a cathode active material layer, and a cathode current collector layer in the stated order. In this case, the electrode active material layer containing the electrode composite of the present disclosure may be the anode active material layer or the cathode active material layer, and may particularly be the anode active material layer.

The battery of the present disclosure may be a liquid battery or a solid-state battery, and may particularly be a solid-state battery. In the present disclosure, the “solid-state battery” refers to a battery that uses at least a solid electrolyte as the electrolyte. Therefore, the solid-state battery may use a combination of the solid electrolyte and a liquid electrolyte as the electrolyte. The solid-state battery may be an all-solid-state battery, that is, a battery that uses only a solid electrolyte as the electrolyte.

The battery of the present disclosure may be a primary battery or a secondary battery, and may particularly be a lithium ion secondary battery.

Each element constituting the battery of the present disclosure will be described below. Description will be given below about an example in which the electrode active material layer containing the electrode composite of the present disclosure is the anode active material layer.

### Anode Current Collector Layer

The anode current collector layer may be in the form of a foil, plate, mesh, punched metal, foam, etc. The anode current collector layer may be a metal foil or a metal mesh, or may be a carbon sheet, and may particularly be a metal foil. The anode current collector layer may be made of a plurality of foils, sheets, etc.

The metal constituting the anode current collector layer is not particularly limited, and may be, for example, copper, nickel, chromium, gold, platinum, silver, aluminum, iron, titanium, zinc, cobalt, or stainless steel. In particular, the anode current collector layer may contain at least one metal selected from among copper, nickel, and stainless steel.

For the purpose of, for example, adjusting the resistance, a coating layer may be formed on the surface of the anode current collector layer. The anode current collector layer may also be formed by plating or depositing, by vapor deposition, any of the above metals onto a metal foil or a substrate. When the anode current collector layer is made of a plurality of metal foils, it may further include a layer interposed between the metal foils.

The thickness of the anode current collector layer is not particularly limited, but may be, for example, 0.1 μm or more, or 1 μm or more, and may be 1 mm or less, or 100 μm or less.

### Anode Active Material Layer

The anode active material layer contains the electrode composite of the present disclosure. For the electrode composite of the present disclosure, the above description regarding the electrode composite of the present disclosure can be referenced. The anode active material layer may be formed by molding the electrode composite of the present disclosure into a layer.

The thickness of the anode active material layer is not particularly limited, and may be, for example, 0.1 μm or more and 1000 μm or less.

### Solid Electrolyte Layer

The solid electrolyte layer contains at least a solid electrolyte, and may optionally further contain a binder etc.

For the solid electrolyte and the binder, the above description regarding the electrode composite of the present disclosure can be referenced.

The thickness of the solid electrolyte layer is not particularly limited, and may be, for example, 0.1 μm or more and 1000 μm or less.

### Cathode Active Material Layer

The cathode active material layer contains at least a cathode active material, and may optionally further contain a solid electrolyte, a conductive aid, a binder, etc.

The cathode active material is not particularly limited, and may be, for example, an oxide active material. When the battery of the present disclosure is a lithium ion secondary battery, the oxide active material may be, for example, LiCoO₂, LiMnO₂, Li₂NiMn₃O₈, LiVO₂, LiCrO₂, LiFePO₄, LiCoPO₄, LiNiO₂, or LiNi_{1/3}Co_{1/3}Mn_{1/3}O₂. A coating layer containing a Li-ion conductive oxide such as LiNbO₃ may be formed on the surface of these active materials.

The content of the cathode active material in the cathode active material layer is not particularly limited.

For the solid electrolyte, the conductive aid, and the binder, the above description regarding the electrode composite of the present disclosure can be referenced.

The thickness of the cathode active material layer is not particularly limited, and may be, for example, 0.1 μm or more and 1000 μm or less.

### Cathode Current Collector Layer

The cathode current collector layer may be in the form of a foil, plate, mesh, punched metal, foam, etc. The cathode current collector layer may be a metal foil or a metal mesh, and may particularly be a metal foil. The cathode current collector layer may be made of a plurality of foils.

The metal constituting the cathode current collector layer may be copper, nickel, chromium, gold, platinum, silver, aluminum, iron, titanium, zinc, cobalt, stainless steel, etc., and the cathode current collector layer may particularly contain aluminum.

For the purpose of, for example, adjusting the resistance, a coating layer may be formed on the surface of the cathode current collector layer. The cathode current collector layer may also be formed by plating or depositing, by vapor deposition, any of the above metals onto a metal foil or a substrate. When the cathode current collector layer is made of a plurality of metal foils, it may further include a layer interposed between the metal foils.

The thickness of the cathode current collector layer is not particularly limited, but may be, for example, 0.1 μm or more, or 1 μm or more, and may be 1 mm or less, or 100 μm or less.

### Other Structures

The battery may be a battery in which the above components are housed inside an outer casing. The outer casing may be any known outer casing for a battery. A plurality of batteries may be electrically connected in any desired manner and stacked in any desired manner to form a battery pack. In this case, the battery pack may be housed inside a known battery case. The battery may also include other obvious components such as necessary terminals. The shape of the battery may be, for example, a coin shape, a laminate (pouch) shape, a cylindrical shape, or a rectangular shape.

### Method for Manufacturing Battery

The method for manufacturing the battery of the present disclosure is not particularly limited, and includes, for example, forming an electrode active material layer containing the electrode composite of the present disclosure.

An example of the method for forming the electrode active material layer containing the electrode composite is a method in which constituent materials such as electrode active material particles are mixed to obtain an electrode composite and the obtained electrode composite is then formed by dry or wet molding.

When the battery is a solid-state battery, the electrode active material layer may be pressed for densification.

The method for manufacturing the battery of the present disclosure may further include laminating an anode current collector layer, an anode active material layer, a solid electrolyte layer, a cathode active material layer, and a cathode current collector layer in the stated order to form an electrode laminate.

If necessary, members such as terminals are attached to the electrode laminate. The electrode laminate is housed in a battery case and sealed to obtain a battery.

### Example 1

### Preparation of Nanoporous Silicon Particles

A lithium silicon (LiSi) precursor was obtained by mixing 0.65 g of silicon (Si) particles (particle size: 1 μm) and 0.60 g of metallic lithium (Li) (produced by Honjo Metal Co., Ltd.) in an agate mortar under an argon (Ar) atmosphere. In a glass reactor under an Ar atmosphere, 1.0 g of the obtained LiSi precursor and 125 ml of 1,3,5-trimethylbenzene (produced by Nacalai Tesque, Inc.) as a dispersion medium were mixed using an ultrasonic homogenizer (UH-50, manufactured by SMT Co., Ltd.). Then, the obtained LiSi precursor dispersion was cooled to 0° C., and 125 ml of ethanol (produced by Nacalai Tesque, Inc.) was added dropwise, followed by reaction for 120 minutes. After the reaction, 50 ml of acetic acid (produced by Nacalai Tesque, Inc.) was further added dropwise, and the reaction was continued for 60 minutes. After the reaction, the liquid and the solid reactant were separated by suction filtration. The obtained solid reactant was dried under vacuum at 120° C. for 2 hours to obtain nanoporous Si particles as Si particles.

### Preparation of Electrode Active Material Composite Particles

### First Slurry Providing Step

A first slurry was prepared by dispersing the nanoporous Si particles as electrode active material particles in a solution prepared by dissolving or dispersing polyvinylidene difluoride-polyhexafluoropropylene copolymer (PVDF-HFP) as a fluorine-based polymer that is a binder in an organic solvent as a first dispersion medium.

### Preliminary Composite Particle Preparation Process

The organic solvent as the first dispersion medium in the first slurry was dried and removed by spray drying to prepare preliminary composite particles.

### Second Slurry Providing Step

A second slurry was prepared by dispersing the preliminary composite particles in a solution prepared by dissolving or dispersing styrene butadiene rubber (SBR) as a non-fluorine-based polymer that is a binder in an organic solvent as a second dispersion medium.

### Second Dispersion Medium Drying and Removing Step

The organic solvent as the second dispersion medium in the second slurry was dried and removed by spray drying to prepare electrode active material composite particles.

For the electrode active material composite particles obtained in this way, SEM-EDX was performed to check that the content ratio of the fluorine-based polymer in the inner region of the composite particle was greater than the content ratio of the fluorine-based polymer in the outer region of the composite particle, and the content ratio of the non-fluorine-based polymer in the outer region of the composite particle was greater than the content ratio of the non-fluorine-based polymer in the inner region of the composite particle. The content ratio of the fluorine-based polymer and the content ratio of the non-fluorine-based polymer with respect to 100 parts by mass of the Si particles are as shown in Table 1.

### Formation of Anode Active Material Layer

The obtained composite particles, a binder, a conductive aid, and a solid electrolyte were added to an organic solvent. Then, the mixture was kneaded using an ultrasonic homogenizer to obtain an anode composite slurry. The obtained anode composite slurry was applied to a copper (Cu) foil as an anode current collector layer to form an anode active material layer. That is, in the present example, an electrode active material layer made of the electrode composite containing the electrode active material composite particles of the present disclosure was used as the anode active material layer.

### Formation of Solid Electrolyte Layer

A binder and a solid electrolyte were added to an organic solvent. Then, the mixture was kneaded using an ultrasonic homogenizer to obtain a solid electrolyte composite slurry. The obtained solid electrolyte composite slurry was applied to an aluminum (Al) foil as a release sheet to form a solid electrolyte layer. A total of three solid electrolyte layers were formed in the same procedure.

### Formation of Cathode Active Material Layer

A binder, a conductive aid, a solid electrolyte, and LiNi_{0.8}Co_{0.15}Mn_{0.05}O₂ as a cathode active material were added to an organic solvent. Then, the mixture was kneaded using an ultrasonic homogenizer to obtain a cathode composite slurry. The obtained cathode composite slurry was applied to an Al foil as a cathode current collector layer to form a cathode active material layer.

### Fabrication of Evaluation Battery

Each of the obtained layers was formed into a strip shape. The cathode active material layer and the solid electrolyte layer were laminated to face each other, and then roll-pressed at 165° C. under a pressure of 50 kN/cm. The Al foil as the release sheet was peeled off from the solid electrolyte layer, thereby transferring the solid electrolyte layer onto the cathode active material layer.

The anode active material layer and the solid electrolyte layer were laminated to face each other, and then roll-pressed at 25° C. under a pressure of 50 kN/cm. The Al foil as the release sheet was peeled off from the solid electrolyte layer, thereby transferring the solid electrolyte layer onto the anode active material layer.

The anode active material layer to which the solid electrolyte layer was transferred and the cathode active material layer to which the solid electrolyte layer was transferred were punched out using punching machines with diameters of 13.00 mm and 11.28 mm, respectively.

A further solid electrolyte layer punched out to a predetermined size was transferred onto the solid electrolyte layer laminated on the anode active material layer using a uniaxial press. Then, the anode active material layer was laminated with the solid electrolyte layer side facing the solid electrolyte layer side of the cathode active material layer to obtain an electrode laminate.

Current extraction tabs were attached to the cathode active material layer and the anode active material layer, and the obtained electrode laminate was sealed in an Al laminate using a vacuum laminate sealer and restrained under a pressure of 5 MPa, thereby fabricating an all-solid-state battery of Example 1.

### Evaluation

The irreversible capacity of the obtained all-solid-state battery was calculated as a specific capacity obtained by normalizing the charging and discharging capacities measured under the following conditions with the weight of the cathode active material:
Initial charging: constant current-constant voltage (CC-CV) charging, upper limit voltage of 4.2 V, 0.1 C to 0.01 C cut
Initial discharging: constant current-constant voltage (CC-CV) discharging, lower limit voltage of 3.0 V, 0.1 C to 0.01 C cut

Irreversible capacity=initial charging capacity−initial discharging capacity

The results are shown in Table 1. The irreversible capacities shown in Table 1 are relative values when the irreversible capacity of Comparative Example 1 described later is set to 1.00.

### Examples 2 to 5

All-solid-state batteries of Examples 2 to 5 were fabricated and evaluated in the same manner as in Example 1, except that the content ratio of the fluorine-based polymer and the content ratio of the non-fluorine-based polymer with respect to 100 parts by mass of the Si particles were changed as shown in Table 1. The results are shown in Table 1.

### Comparative Examples 1 and 2

All-solid-state batteries of Comparative Examples 1 and 2 were fabricated and evaluated in the same manner as in Example 1, except that the content ratio of the fluorine-based polymer with respect to 100 parts by mass of the Si particles was as shown in Table 1 and the second slurry providing step and the subsequent step were not performed such that the outer region did not contain the non-fluorine-based polymer.

TABLE 1

| | Fluorine-based polymer | | Non-fluorine-based polymer | | |
|---|---|---|---|---|---|
| | | Content ratio | | Content ratio | |
| | | with respect | | with respect | |
| | | to 100 parts | | to 100 parts | |
| | | by mass of | | by mass of | Irreversible |
| | | Si particles | | Si particles | capacity |
| | Type | [part by mass] | Type | [part by mass] | [—] |
| Comparative Example 1 | PVDF-HFP | 10 | — | — | 1.00 |
| Comparative Example 2 | PVDF-HFP | 15 | — | — | 1.19 |
| Example 1 | PVDF-HFP | 10 | SBR | 0.5 | 0.95 |
| Example 2 | PVDF-HFP | 10 | SBR | 1 | 0.61 |
| Example 3 | PVDF-HFP | 10 | SBR | 5 | 0.65 |
| Example 4 | PVDF-HFP | 10 | SBR | 10 | 0.97 |
| Example 5 | PVDF-HFP | 15 | SBR | 5 | 0.67 |

As shown in Table 1, the irreversible capacities were small in the batteries of the examples each containing the electrode active material composite particles of the present disclosure in which the content ratio of the fluorine-based polymer in the inner region of the composite particle was greater than the content ratio of the fluorine-based polymer in the outer region of the composite particle, and the content ratio of the non-fluorine-based polymer in the outer region of the composite particle was greater than the content ratio of the non-fluorine-based polymer in the inner region of the composite particle. In particular, the irreversible capacities were even smaller in the batteries of Examples 2 and 3 in which the content ratio of the non-fluorine-based polymer with respect to the Si particles was adjusted.

What is claimed is:

1. An electrode active material composite particle that is a composite particle comprising a plurality of silicon particles and a binder, wherein
the binder contains a fluorine-based polymer and a non-fluorine-based polymer,
a content ratio of the fluorine-based polymer in an inner region of the composite particle is greater than a content ratio of the fluorine-based polymer in an outer region of the composite particle, and
a content ratio of the non-fluorine-based polymer in the outer region of the composite particle is greater than a content ratio of the non-fluorine-based polymer in the inner region of the composite particle.

2. The electrode active material composite particle according to claim 1, wherein:
a content ratio of the fluorine-based polymer with respect to 100 parts by mass of the silicon particles is 30 parts by mass or less; and
a content ratio of the non-fluorine-based polymer with respect to 100 parts by mass of the silicon particles is 15 parts by mass or less.

3. An electrode composite comprising the electrode active material composite particle according to claim 1.

4. A battery comprising an electrode active material layer, wherein
the electrode active material layer contains the electrode composite according to claim 3.

5. A method for producing the electrode active material composite particle according to claim 1, the method comprising:
providing a first slurry containing the silicon particles, the fluorine-based polymer, and a first dispersion medium;
drying and removing the first dispersion medium by spray drying to prepare a preliminary composite particle;
providing a second slurry containing the preliminary composite particle, the non-fluorine-based polymer, and a second dispersion medium; and
drying and removing the second dispersion medium by spray drying.
